(19) United States
(12) Patent Application Publication
(10) Pub. No.: US 2024/0397073 A1
(43) Pub. Date: Nov. 28, 2024

(54) Accelerating the Processing of a Stream of Media Data Using a Client Media Engine

(71) Applicant: Microsoft Technology Licensing, LLC, Redmond, WA (US)

(72) Inventors: Mikko Henrik SIMONEN, Tampere (FI); Matthew Don MORRIS, Seattle, WA (US); Alberto Jose MARTINEZ, Kirkland, WA (US); Edward GAMSARAGAN, Kirkland, WA (US); Balaji Ravi Kumar BADAM, Cupertino, CA (US)

(73) Assignee: Microsoft Technology Licensing, LLC, Redmond, WA (US)

(21) Appl. No.: 18/200,988

(22) Filed: May 23, 2023

(51) Int. Cl. H04N 19/44; H04N 19/174; H04N 21/2343; H04N 21/235

(52) U.S. Cl. CPC H04N 19/44; H04N 19/174; H04N 21/234363; H04N 21/2351

(57) ABSTRACT

A technique processes a stream of media data in an accelerated manner using a media engine provided by a client system. The media engine performs this task, under direction of a local controller, using a pipeline of integrated inline media-processing operations having access to local memory. The operations include: decrypting received encrypted media data to produce decrypted media data; decoding the decrypted media data to produce decoded media data; and enhancing the decoded media data to produce enhanced media data. In some cases, the enhanced media data has a resolution that is greater than the resolution of the received decrypted media data. In some implementations, the client system is implemented as a system-on-chip, and the media engine is a component of the system-on-chip.

### BACKGROUND

In a traditional approach, a client device processes a stream of media data using standalone modules that perform different respective tasks. The main processing system of the client device coordinates interaction among these standalone modules, along with its other management responsibilities. This traditional solution exhibits adequate performance in many streaming contexts. But the traditional solution requires a significant amount of resources. This characteristic makes it potentially unsuitable for those computing platforms with limited resources, and those streaming applications in which energy efficiency is an important design objective. Further, the traditional solution has latency characteristics that may make it non-optimal for those streaming applications that require timely feedback to user input actions. These applications include gaming applications, video-conferencing applications, etc.

### SUMMARY

A technique is described herein for processing a stream of media data in an accelerated manner using a client-side media engine. The technique involves receiving encrypted media data at a client system. The encrypted media data is generated by a source system (e.g., a server system) at a first resolution. The client system then instructs the media engine to process the stream of media data. The media engine performs this task, under direction of a local controller, by applying an integrated pipeline of media-processing operations.

In some implementations, the integrated media-processing operations include: decrypting the encrypted media data to produce decrypted media data; decoding the decrypted media data to produce decoded media data; and enhancing the decoded media data to produce enhanced media data. In some cases, the enhanced media data has a second resolution that is greater than the first resolution (of the received media data). The above-summarized media-processing operations make use of local memory available to the media engine.

As will be described in the Detailed Description, the technique consumes fewer resources than the traditional approach (which involves interaction with standalone processing modules, under direction of a main processing system of the client system). Further, the technique offers superior latency-related performance compared to the traditional approach. This makes the technique suitable for use in streaming applications that require timely responses to user input actions.

This Summary is provided to introduce a selection of concepts in a simplified form; these concepts are further described below in the Detailed Description. This Summary is not intended to identify key features or essential features (or key/essential advantages) of the claimed subject matter, nor is it intended to be used to limit the scope of the claimed subject matter.

### BRIEF DESCRIPTION OF THE DRAWINGS

FIG. 1 shows a streaming system in which a server system streams media data to a client system.

FIG. 2 shows one implementation of the streaming system of FIG. 1.

FIG. 3 shows functionality that enables the client system of FIG. 1 to process video data.

FIG. 4 shows functionality that enables the client system of FIG. 1 to process audio data.

FIG. 5 shows the partitioning of a frame of video data into plural tiles.

FIG. 6 illustrates a first format conversion performed by the functionality of FIG. 4, in some implementations.

FIG. 7 illustrates a second format conversion performed by the functionality of FIG. 4, in some implementations.

FIG. 8 shows functionality that enables the client system of FIG. 1 to receive and process input data.

FIG. 9 is a timing diagram that provides an overview of one illustrative manner of operation of the client system of FIG. 1.

FIG. 10 is a timing diagram that illustrates one illustrative way in which the client system of FIG. 1 processes video data.

FIG. 11 shows a process that describes preliminary processing operations performed by the client system of FIG. 1.

FIG. 12 shows a process that describes media-processing operations performed by the client system of FIG. 1.

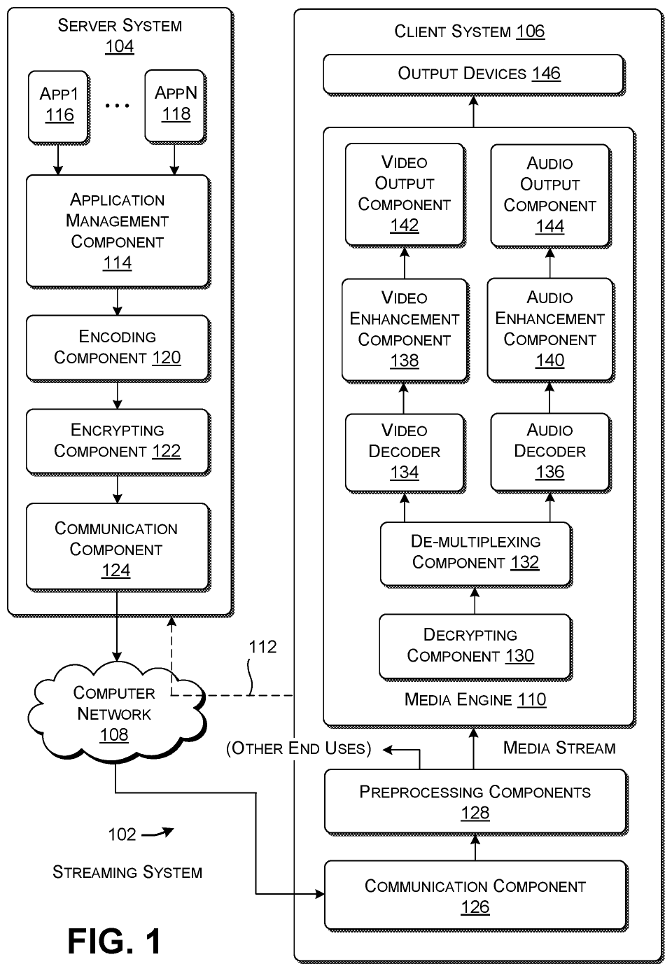

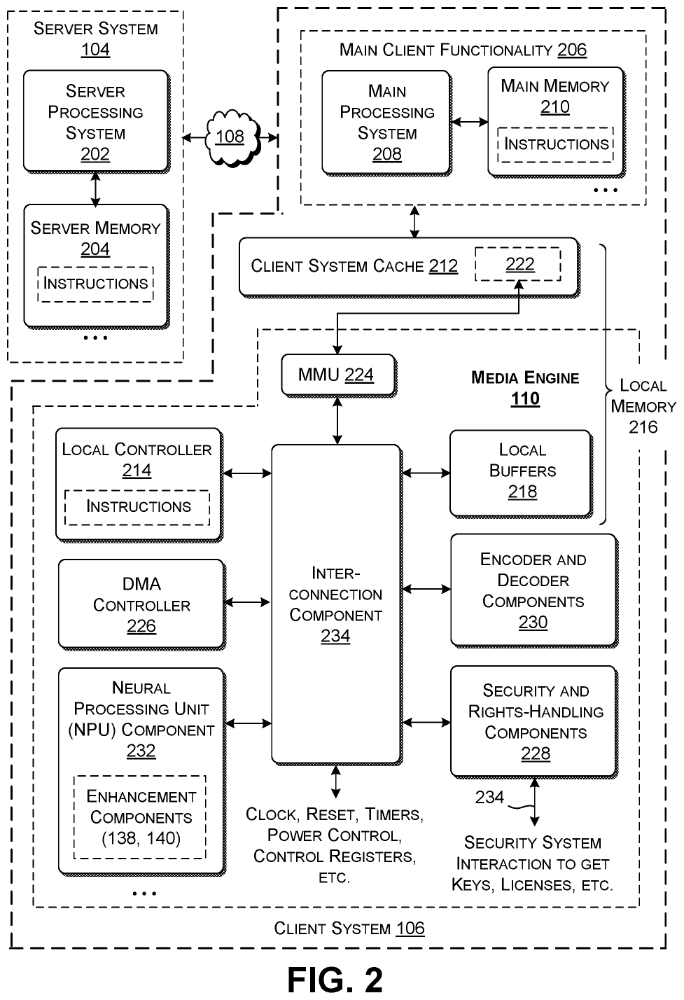

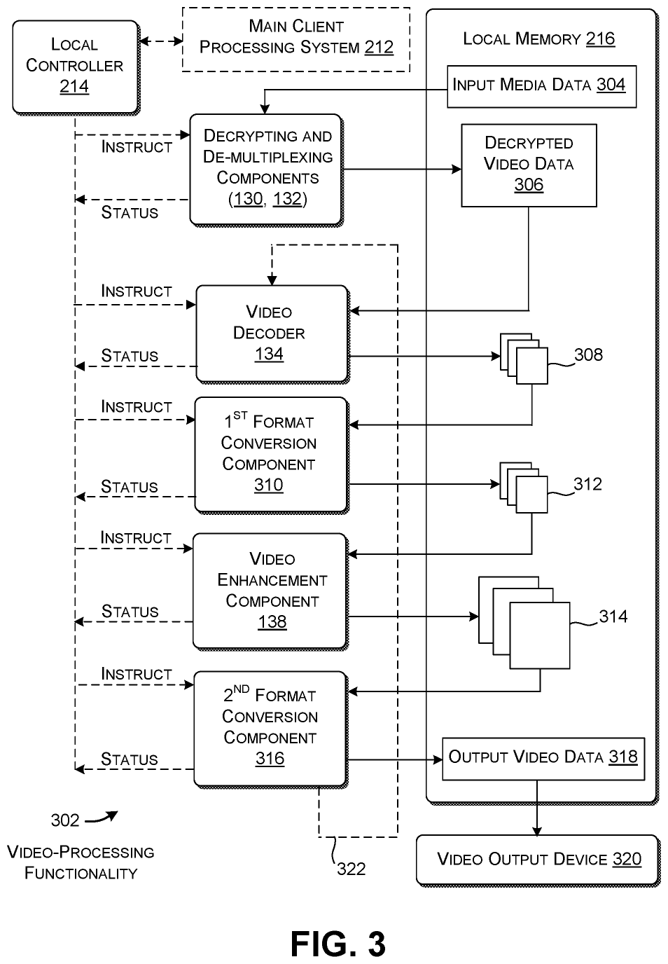

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

FIG. 1 shows a streaming system 102 in which a server system 104 streams media data to a client system 106. In some implementations, the server system 104 is implemented by one or more servers, provided at one or more locations. The client system 106 corresponds to any type of computing functionality with which an end user interacts. Examples of client systems include a desktop computing device, a handheld computing device of any type (e.g., a smartphone), a game console, an entertainment system, an intelligent appliance, a virtual or mixed reality headset, a computer-equipped vehicle, and so on. The client system 106 is communicatively coupled to the server system 104 via any type of computer network 108, including a local area network, a wide area network (such as the Internet), etc.

The term “media data” includes any type (or combination of types) of digital data that is delivered to the user in streaming fashion. In most of the examples presented herein, the media data corresponds to audio-visual content that includes video data and audio data. The video data is composed of a sequence of frames of image content. In other cases, the media data includes video data with no audio accompaniment. In other cases, the media data includes audio data with no video accompaniment. In other examples, the media data includes any type of computer-generated content (such as remote desktop information), sensor data, etc.

A “machine-trained model” refers to computer-implemented logic for executing a task using machine-trained weights that are produced in a training operation. A “weight” refers to any type of parameter value that is iteratively produced by the training operation. In some contexts, terms such as “component,” “module,” “engine,” and “tool” refer to parts of computer-based technology that perform respective functions. FIG. 2, described below, provides one example of illustrative computing equipment for performing these functions.

By way of overview, the client system 106 accelerates the processing of the media data using a hardware-implemented media engine 110. A main processing system (not shown in FIG. 1) of the client system 106 invokes the media engine 110 upon the receipt of encrypted media data from the server system 104. Thereafter, the media engine 110 performs an integrated series of media-processing operations on the encrypted media data. The media engine 110 performs these media-processing operations using a local controller (not shown in FIG. 1) and a local memory (not shown in FIG. 1), largely independent of the main processing system.

The focus of the following explanation will be on the flow of media data from the server system 104 to the client system 106. However, as represented by path 112, the client system 106 is also capable of forwarding input data to the server system 104 to control whatever application is providing the media data. Consider the example in which the server system 104 streams game-related content to the client system 106. The path 112 in this case represents the user's control instructions made while interacting with the game-related content. The server system 104 responds to the user's control instructions by modifying the flow of game-related content provided in the client system 106.

In the above example, the media engine 110 reduces the latency at which the client system 106 is able to process and present the game-related content. This, in turn, reduces the overall lag between a user's input action and the delivery of the game-related content that reflects the user's input action. The user will experience these latency improvements as an increase in the responsiveness of the game application, making it seem less “sluggish.” The media engine 110 offers similar benefits with respect to other applications, such as video-conferencing related applications.

Further detail regarding the individual illustrative components of the streaming system 102 begins with an explanation of the server system 104. In some implementations, an application management component 114 produces media data by integrating plural instances of media data provided by two or more applications (116, . . . , 118). In some implementations, for instance, the application management component 114 corresponds to a cloud-implemented version of WINDOWS DESKTOP MANAGER, produced by MICROSOFT CORPORATION of Redmond, Washington. In other cases, the application management component 114 provides a stream of media data produced by a single application, such as a game application or video-conferencing application.

In some implementations, the applications (116, . . . , 118) produce media content at a first resolution (R1). Upon receipt of the media data, the media engine 110 increases the resolution of the media data to a second resolution R2, where R2>R1. For example, at least one of the applications (116, . . . , 118) produces media data at a resolution of 720p, and the media engine 110 increases the resolution to 1440p. In other implementations, the applications (116, . . . , 118) produce media data at full resolution, and a server-side component reduces the resolution of the media data prior to transmission to the client system 106, which restores the media data to a higher resolution, such as its original full resolution (or greater).

By virtue of producing lower-resolution media data, the streaming system 102 reduces its consumption of resources and improves its latency-related performance, without degrading the experience of the user who eventually consumes the media data. For instance, by producing lower-resolution media data, both the server system 104 and the client system 106 are able to increase the speed at which they process the media data, and reduce the amount of resources in doing so. This is because the amount of time and resources involved in processing data decreases with a decrease in the amount of data to process. As a further consequence, the server system 104 and client system 106 require less energy to run and emit less heat. The equipment used to implement computer network 108 benefits from the use of lower-resolution media data for similar reasons.

An encoding component 120 encodes the media content provided by the application management component 114, to produce encoded media data. The process of encoding involves compressing the media data and expressing the media data in a particular format. The encoding component 120 may rely on any encoding standard to perform its task, including H.264/AVC, H.265/AVC, AV1, VP9, etc. (AVC refers to Advance Video Coding). An encrypting component 122 encrypts the encoded media data, to produce decrypted media data. The encrypting component 122 may rely on any encryption standard to perform this task, such as the Advanced Encryption Standard (AES).

Alternatively, or in addition, the server system 104 uses a particular streaming protocol to stream the media data, such as REMOTE DESKTOP PROTOCOL (RDP) provided by MICROSOFT CORPORATION, WEBRTC provided by GOOGLE LLC of Mountain View, California, NANOSTREAM provided by NANOCOSMOS GMBH of Berlin, Germany, etc. In such cases, the server system 104 uses the encoding functionality and encrypting functionality specified by these streaming protocols, by itself or as an additional layer of encoding and security.

Finally, a communication component 124 transmits the encrypted media data over the computer network 106. The communication component 124 performs this task by using a communication stack (not shown), and by applying any protocol-specific processing. The protocol-specific processing can include network-level encryption.

In other examples, the source of the media data is another source computing system, other than the server system 104. For example, another client system, operated by a first user, may generate and transmit the media data to the client system 106 shown in FIG. 1, operated by a second user. The originating client system can use the same functionality described above to do so. Further, the originating client system may, at times, receive media data from the client system 106 shown in FIG. 1, and may process the media data using the same pipeline of media-processing operations described below. To facilitate and simplify the following explanation, however, this disclosure will emphasize the example shown in FIG. 1 in which the server system 104 is the source computing system.

With respect to the client system 106, a communication component 126 receives and processes the encrypted media data. The commination component 126 performs this task by using a network driver, and by applying any protocol-specific processing (including network-level decryption), Virtual Private Network (VPN) processing or other network security processing, etc.

A preprocessing component 128 performs any preliminary operations on the encrypted media data, including any application-specific preliminary operations. In part, the preprocessing component 128 determines whether the received data includes a stream of media data. If this is the case, the preprocessing component 128 forwards the encrypted media data to the media engine 110. If the received data does not include stream of media data, the preprocessing component 128 routes the received data to whatever application logic is appropriate to process this data. In other cases, the received data includes streaming media data and other data. Here, the preprocessing component 128 routes the encrypted media data to the media engine 110 and the other data to the appropriate application logic.

Upon receiving the encrypted media data, the media engine 110 invokes an integrated flow of operations. The local controller (not shown in FIG. 1) of the media engine 110 governs the execution of these tasks. For instance, the local controller instructs individual components of the media engine 110 to begin their processing. The local controller also collects status information produced by the individual components of the media engine 110, which reflect the status of operations performed by these components. In this regard, the local controller operates as a hardware scheduler.

The media engine 110 performs most of its tasks independent of the functions performed by a main processing system (not shown) of the client system 106. The client system 106 thereby reduces the processing burden placed on the main processing system. As a further result, the main processing system is able to dedicate more resources to other applications that are running, thereby potentially improving their performance. Alternatively, the main processing system may enter a low power state if it has no other tasks to perform. Doing so reduces the client system's consumption of power.

In some implementations, a decrypting component 130 begins the flow of operations by decrypting the encrypted media data. This is media-level decryption; note that the communication component 126 can perform preliminary network-level decryption. The output of the decrypting component 130 is decrypted media data. In some implementations, the decrypting component 130 uses AES decryption for media data that has been encrypted using this standard.

In some implementations, the decrypting component 130 performs its tasks as part of Digital Rights Management (DRM) operations and/or other authentication and permission-checking operations. DRM operations involve verifying that the client system 106 is duly authorized to consume the media data by determining whether environment-specific rules specified in license information are satisfied, and, if so, decrypting the media data using client-supplied decryption key information. In some instances, the application of the rules involves comparing client (and/or user) information with environment-specific use-restriction information.

A de-multiplexing component 132 separates decrypted video data from decrypted audio data in the decrypted media data. The media engine 110 processes the decrypted video data using a first pipeline. In parallel therewith, the media engine 110 process the decrypted audio data using a second pipeline.

In particular, in some implementations, a video decoder 134 and audio decoder 136 decode the decrypted video data and the decrypted audio data, respectively. This yields decoded video data and decoded audio data. The video decoder 134 and the audio decoder 136 perform decoding using functionality that complements whatever standard was used to encode the audio data and video data (including any of H.264/AVC, H.265/AVC, AV1, V9, etc.). Decoding generally incudes decompressing the decrypted media data and performing any other related tasks (such as motion correction in the case of the decrypted video data). Alternatively, or in addition, the encoding component 120 of the server system 104 uses a machine-trained model to encode the media data. Here, the video decoder 134 and the audio decoder 136 use a complementary machine-trained model to decode the decrypted video data and decrypted audio data.

A video enhancement component 138 increases the resolution of the decoded video data, and the audio enhancement component 140 enhances the resolution of the audio data. For example, in those cases in which the server system 104 has produced media data a first (low) resolution (R1), the video enhancement component 138 and audio enhancement component 140 increase the resolution of the media data to a second (higher) resolution (R2). Alternatively, or in addition, the video enhancement component 138 and audio enhancement component 140 perform any other operations that have the effect of improving the quality of the decoded media data. These operations include: cropping, brightness control, color adjustment, removal of artifacts, classification of objects within the media data, adding closed captioning, blurring of specified kinds of objects (e.g., faces), and so on. The output of the video enhancement component 138 and the audio enhancement component 140 is referred to herein as enhanced video data and enhanced audio data, respectively.

In some implementations, the video enhancement component 138 and/or the audio enhancement component 140 perform their tasks using, at least in part, machine trained models. For example, the machine-trained models can include deep neural networks of any type(s), including Convolutional Neural Networks (CNNs), transformer-based networks, Recurrent Neural Networks (RNNs), and so on. In a training process, a training system (not shown) trains one kind of machine-trained model that performs super resolution by iteratively decreasing the errors in the model's processing of low resolution (LR) input images, relative to ground-truth images that correspond to correct high resolution (HR) counterparts of the LR input images.

Background information on the general topic of model-driven super resolution can be found at: Anwar, et al., “A Deep Journey into Super-resolution: A Survey,” arXiv, Cornell University, arXiv:1904.07523v3 [cs.CV], Mar. 23, 2020, 21pages; and Liu, et al., “Video Super-Resolution Based on Deep Learning: A Comprehensive Survey,” arXiv, Cornell University, moarXiv:2007.12928v3 [cs.CV], Mar. 16, 2022, 33 pages. The industry also offers stand-alone functionality that is dedicated to the task of super resolution, such as the AMD RADEON SUPER RESOLUTION product provided by ADVANCED MICRO DEVICES, INC., of Santa Clara, California.

A video output component 142 and an audio output component 144 perform post-processing operations, with the goal of providing the output results of the media engine 110 to output devices 146 (which constitute an output system). The output results include the enhanced video data and the enhanced audio data. In some implementations, the post-processing operations include retrieving the output results from local memory, formatting the output results for presentation, and forwarding the output results to the output devices 146. In some implementations, the post-processing operations also include merging the output results of the media engine 110 with other display content produced by other processes (not shown) performed by the client system 106. Further, in some implementations, the post-processing operations include encrypting the output results of the media engine 110 prior to transfer. The output devices 146, include any type of display device, any type of sound-delivery device, and/or output devices associated with other modalities (including a haptic output device, etc.). The output devices 146 are coupled to the client system 106 in any way, such as physical cables and/or wireless connection.

FIG. 2 shows one illustrative implementation of the streaming system 102 of FIG. 1. By way of terminology, the term “processing system” as used herein refers to any type of device that performs a processing function, or any combination of different types of devices. For example, a processing system includes a general-purpose Central Processing Unit (CPU), a Graphics Processing Unit (GPU), a Neural Processing Unit (NPU), an application-specific processor, and so on, or any combination thereof. Alternatively, or in addition, a processing system includes any device that performs operations using a collection of programmable or fixed logic gates. One kind of device of this kind is a Field-Programmable Gate Array (FPGA) device. The term “memory” refers to any device for storing information, such as Random Access Memory (RAM) of any type(s). A processing system performs its function by executing machine-trained instructions stored in memory, and/or by executing functions that are embodied in logic gates.

The server system 104 includes a server processing system 202 and server memory 204. The server processing system 202 performs all of the functions described above with respect to FIG. 1 by executing machine-readable instructions stored in the server memory 204 and/or embodied in logic gates.

The client system 106 includes main client functionality 206 that implements all operating system tasks and application tasks of the client system 106 (with the exception of media-processing operations, which are delegated to the media engine 110). The main client functionality 206 includes a main processing system 208 and main memory 210. The main client processing system 208 executes instructions stored in the main memory 210 and/or embodied in logic gates. Further, the main client functionality 206 interacts with a system cache 212 in performing its functions.

The media engine 110 includes a local controller 214. The local controller 214 represents any type of processing system that is dedicated to the task of managing the integrated flow of media-processing operations described above in the context of FIG. 1. The local controller 214 is driven by computer-readable instructions, which it stores as part of its hardcoded logic, and/or as provided in a separate instruction store (not shown).

The media engine 110 interacts with local memory 216. Different implementations of the media engine 110 can implement the local memory 216 in different respective ways. In the example of FIG. 2, the local memory 216 includes one or more buffers 218 and a dedicated part 222 of the system cache 212. In other cases, the local memory is entirely implemented by the buffers 218. In view thereof, any storage operation set forth below that involves the system cache 212 can be replaced by an operation that involves interaction with the buffers 218 and/or some other form of local memory.

The media engine 110 further optionally includes a Memory Management Unit (MMU) 224 and a Direct Memory Access (DMA) controller 226 for assisting in the transfer of media data between components. That is, among other tasks, the MMU 224 performs address translation between different storage spaces. The DMA controller 226 transfers blocks of media data among the components of the media engine 110, which enables the local controller 214 to perform other tasks during the transfer operations. Other implementations use other memory access mechanisms besides the MMU 224, or in addition to the MMU 224. In addition, or alternatively, other implementations use other memory access mechanisms besides the DMA controller 226, or in addition to the DMA controller 226.

The media engine 110 also includes specialized engines, including security and rights-handling components 228, encoder and decoder components 230, and a Neural Processing Unit (NPU) 232. The security and rights-handling components 228 implement the decrypting component 130 of FIG. 1 and an encrypting component (not shown). The security and rights-handling components 228 also optionally implement any type of permission-checking functionality, such as digital rights management. The security and rights-handling components 228 rely on information provided by one or more external security systems, as reflected by communication path 234. Such information includes security keys, licenses, user profile information, use restriction information, etc. The encoder and decoder components 230 implement the video decoder 134 and the audio decoder 136 of FIG. 1. The NPU 232 implements the video enhancement component 138 and the audio enhancement component 140 of FIG. 1.

An interconnection component 234 allows interaction among the above-described components. The interconnection component 234 can be implemented as an interaction fabric (also referred to as a mesh), a bus of any type, etc. Finally, FIG. 2 indicates that the media engine 110 interacts with one or more timers, reset functionality, control registers, power management functionality, etc.

In some cases, the media engine 110 is implemented as a discrete hardware unit within the client system 106. For instance, the media engine 110 is implemented as an integrated circuit within a computing device of any type. In other cases, the client system 106 itself is implemented as a system-on-chip. Here, the media engine 110 corresponds to a particular unit on the system-on-chip.

FIG. 3 shows video-processing functionality 302 that enables the client system 106 to process video data. The video-processing functionality 302 will be explained below in the context of the processing of a single frame of video data, corresponding to one frame in a stream of frames of the video data. In performing its functions, the video-processing functionality 302 interacts with the local memory 216, e.g., corresponding to the local buffers 218 and/or the system cache 222, and/or any other memory that is local with respect to the media engine 110.

The decrypting component 130 decrypts input media data 304, and the de-multiplexing component 132 separates the input media data 304 into decrypted video data 306 and decrypted audio data (not shown in FIG. 3). The video decoder 134 decodes the decrypted video data 306, to produce decoded video data 308. An optional first formation conversion component 310 converts the decoded video data 308 from a first format to a second format, to provide converted decoded video data 312. The video enhancement component 138 enhances the decoded video data 312, to produce enhanced video data 314. The enhanced video data 314 has a higher resolution compared to the decoded video data 308. For example, assume that the video decoder 134 produces tiles having a size 192 by 96 pixels (where the use of tiles is explained below). In some implementations, the video enhancement component 138 increases the resolution by a factor of four, to produce tiles having a size of 384 by 192 pixels. An optional second format conversion component 316 converts the enhanced video data 314 from a first format to a second format, to produce converted output video data 318. The video output component 142 (not shown in FIG. 3) retrieves the output video data 318 from local memory 216, and sends it to a video output device 320. A loop 322 indicates that the media engine 110 repeats the above operations for each successive video frame in the decrypted video data 306.

In some implementations, the first format conversion component 310 and the second format conversion component 316 unconditionally perform their operations for all video data. In other implementations, the video-processing functionality 302 conditionally invokes the first format conversion component 310 and the second format conversion component 316. For example, the video-processing functionality 302 invokes the first format conversion component 310 upon detecting that the decoded video data 308 is not in a desired format. Further, the video-processing functionality 302 can conditionally invoke the second format conversion component 316 to accommodate the environment-specific format expectations of the output devices 146.

In some implementations, the first format conversion component 310 is implemented as part of the video decoder 134. The second format conversion component 316 is implemented as a part of the video enhancement component 138. In other implementations, the video-processing functionality 302 implements the first format conversion component 310 and/or the second format conversion component 316 as respective standalone components, or as parts of other components of the media engine 110 (such as the DMA controller 226).

In some implementations, the video decoder 134 formulates the decoded video data 308 as a group of tiles. Similarly, the video enhancement component 138 formulates the enhanced video data 314 as a group of tiles. In both cases, each tile corresponds to an individual section of the video frame being processed.

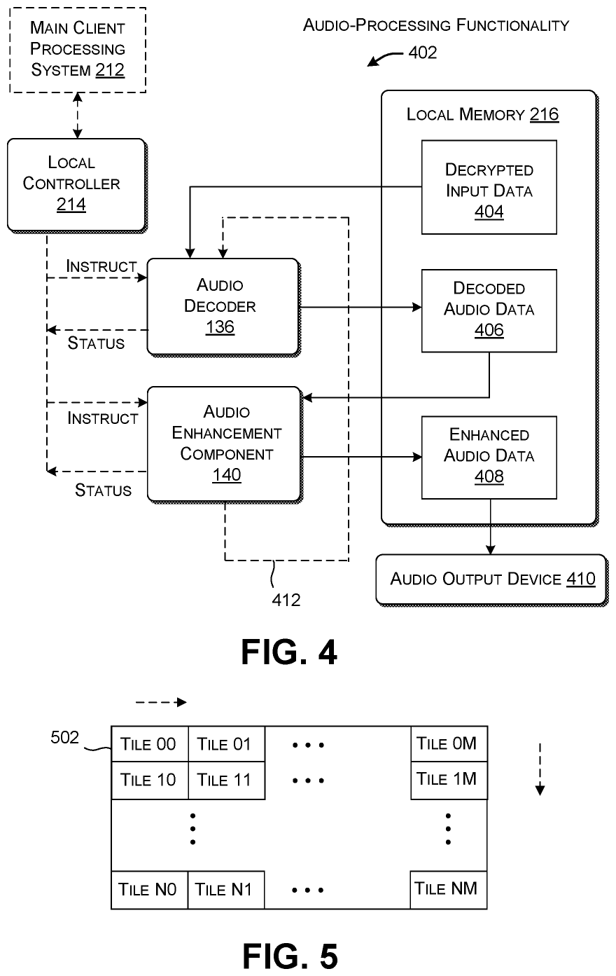

FIG. 4 shows audio-processing functionality 402 that enables the client system 106 to process audio data. Like the video-processing functionality 302, the audio-processing functionality 402 interacts with the local memory 216, e.g., corresponding to the local buffers 218, and/or the system cache 222, and/or any other implementation of memory that is local with respect to the media engine 110.

The audio decoder 136 decodes decrypted audio data 404, to produce decoded audio data 406. The audio enhancement component 140 enhances the decoded audio data 406, to produce enhanced audio data 408. The enhanced audio data 408 has a higher resolution compared to the decoded audio data 406. The audio output component 144 (not shown in FIG. 4) retrieves the enhanced audio data 408 from the local memory 216, and sends it to an audio output device 410. A loop 412 indicates that the media engine 110 repeats the above processing for each successive temporal segment of audio data in the decrypted audio data.

FIGS. 5-7 provide further details regarding one implementation of the video-processing functionality 302 of FIG. 3. Starting with FIG. 5, this figure shows the manner in which the video decoder 134 partitions a video frame 502 into plural tiles. Here, each tile corresponds to a rectangular part of the video frame 502. In some implementations, each tile also overlaps with its neighboring tiles by a prescribed number of pixels, e.g., six pixels. This extension helps reduce boundary-related artifacts in the processing of the tiles. In one example, a video frame processed by the video decoder 134 has a dimension of 1920 pixels by 1080 pixels. The video decoder 134 partitions this video frame into tiles of size 192 pixels by 90 pixels, which are expanded to tiles of size 192by 96 pixels. Other implementations use tiles of other sizes to accommodate environment-specific considerations. Other implementations process whole video frames without the use of tiles.

In some implementations, the video decoder 134 produces a group of tiles (e.g., 8 to 12 tiles), which constitute the decoded video data 308. The video enhancement component 138 receives the input tiles produced by the video decoder 134 as input, and, in response, produces a group of tiles, which make up the enhanced video data 314. Overall, the video-processing functionality 302 processes the tiles in a frame from left to right, and from top to bottom.

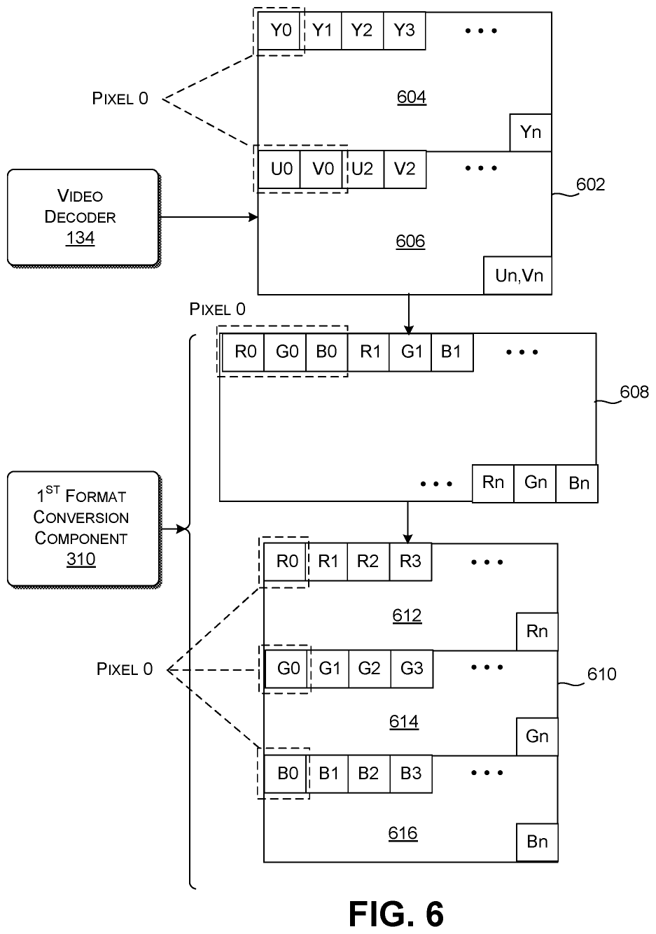

FIG. 6 illustrates one manner in which the first format conversion component 310 converts the format of the decoded video data 308 from a first format to a second format. Assume that the video decoder 134 originally produces tiles of decoded video data in the YUV format, with an illustrative chroma subsampling of 4:2:0. FIG. 6 shows one such illustrative tile 602. In the YUV color format, each pixel is described by an illumination value (Y) and two color values (U, V). A chroma subsampling specification indicates the way in which the color values are sampled to compress a video frame, relative to the luminance values. Consider an array of pixels with a width of 4 pixels and a height of 2 pixels. For the particular case of 4:2:0 subsampling, the “4” indicates that each pixel in this subset is represented by its original luminance value (Y). The “2” indicates that, in the first row of the array, there are half as many color values as luminance values. For instance, the second pixel in the first row shares the same color values as the first pixel in the first row, and the fourth pixel in the first row shares the same color values as the third pixel in the first row. The “0” indicates that each pixel in the second row of the array shares the same color value as its neighboring pixel in the first row (which lies “above” it). In the case of 4:4:4 subsampling, the unique Y, U, and V values of each pixel are preserved.

Further, assume that the video decoder 134 represents the tile 602 of decoded video content in the planar format, that is, as a collection planes, each plane grouping together pixels of the same kind. Here, for instance, a first plane 604 describes the luminance values of the pixels in the tile 602. A second plane 606 describes the color values of the pixels in the tile 602. A particular pixel (e.g., pixel 0) is composed of a luminance value extracted from the first plane 604 and color values extracted from the second plane 606.

The first format conversion component 310 converts the tile 602 from the YUV format to the RGB format, where each pixel has its own red (R), green (G), and blue (B) values. In some implementation, this conversion is accomplished by the following transformations: R=Y+1.140*V, G=Y−0.395*U−0.581*V, and B=Y+2.032*U. In some implementations, the first format conversion component 310 first converts the tile 602 into an RGB image 608 in the raster format, in which the RGB values of consecutive pixels appear sequentially. The first format conversion component 310 then converts the RGB image 608 to a tile 610 in a planar RGB format. Here, the tile 610 includes a first plane 612 for storing the red values of the pixels in the tile 610, a second plane 614 for storing the green values of the pixels in the tile 610, and a third plane 616 for storing blue values of the pixels in the tile 610.

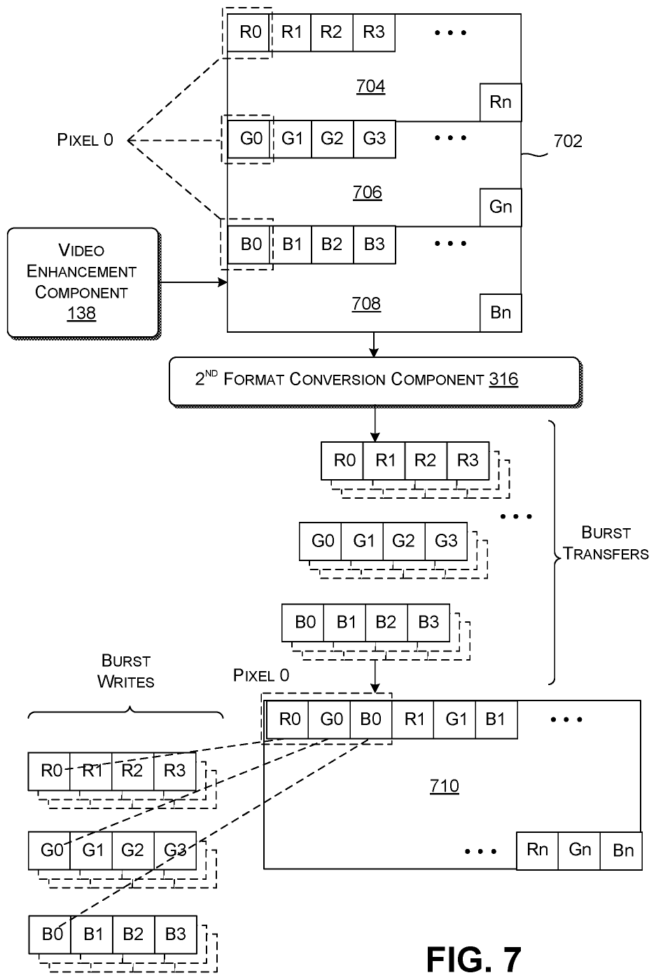

FIG. 7 illustrates one manner in which the second format conversion component 316 converts the format of the enhanced video data produced by the video enhancement component 138 from a first format (e.g., the planar RGB format) to a second format (e.g., raster-packed RGB format). FIG. 7 particularly shows the case in which the video enhancement component 138 produces a tile 702 of enhanced video data in the planar RGB format (which matches the format of the decoded video data fed to the video enhancement component 138). That is, the tile 702 includes a red-pixel plane 704, a green-pixel plane 706, and a blue-pixel plane 708. The second format conversion component 316 converts this video content into a packed RGB raster image 710. In some implementations, the second format conversion component 316 executes a plurality of burst transfers to perform this conversion task. In other implementations, the video output device 320 expects to receive data in the YUV format. The second format conversion component 316 accommodates this expectation by converting the enhanced video data produced by the video enhancement component 138 from the planar RGB format to the YUV format.

Note that the details shown in FIGS. 6 and 7 correspond to one conversion strategy among many that can be used. Further, as stated above, the media engine 110 can dynamically adapt to the format that is used to express the decrypted media data, and the format used by the output devices 146.

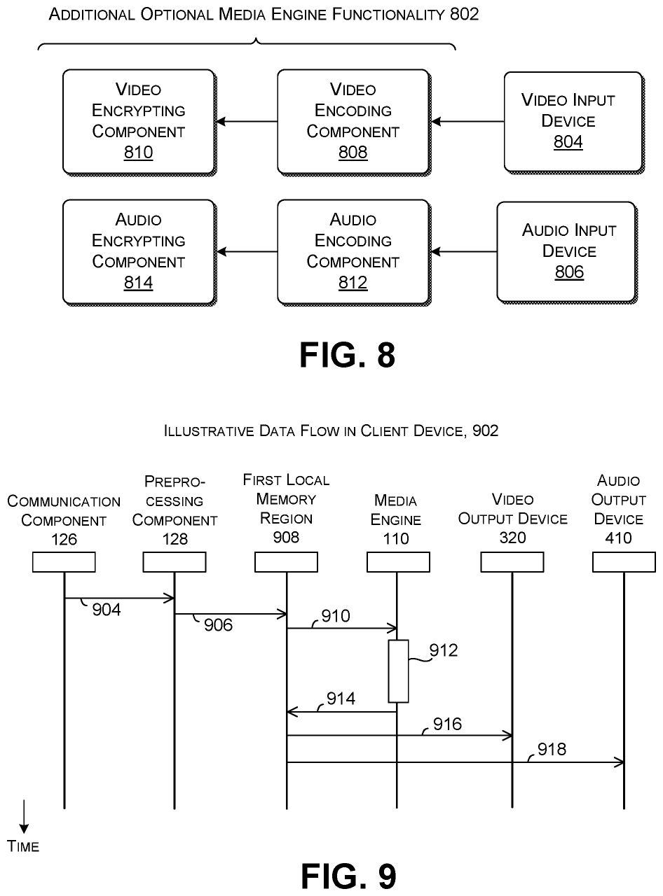

FIG. 8 shows optional functionality 802 that enables the media engine 110 to receive and process input data. In this case, the client system 106 receives input data from one or more input devices. For instance, a video input device 804 (e.g., a video camera) provides input video data, and an audio input device 806 (e.g., a microphone) provides input audio data. Other input devices include a haptic input device that provides haptic data, a three-dimensional scanner that provides three-dimensional data, a sensor that provides any sensor input data, etc. A video encoding component 808 encodes the video input data (e.g., by compressing the data and expressing it in a particular format), and a video encrypting component 810 encrypts the resultant encoded video data (e.g., using AES encryption). Similarly, an audio encoding component 812 encodes the audio input data, and an audio encrypting component 814 encrypts the resultant encoded audio data.

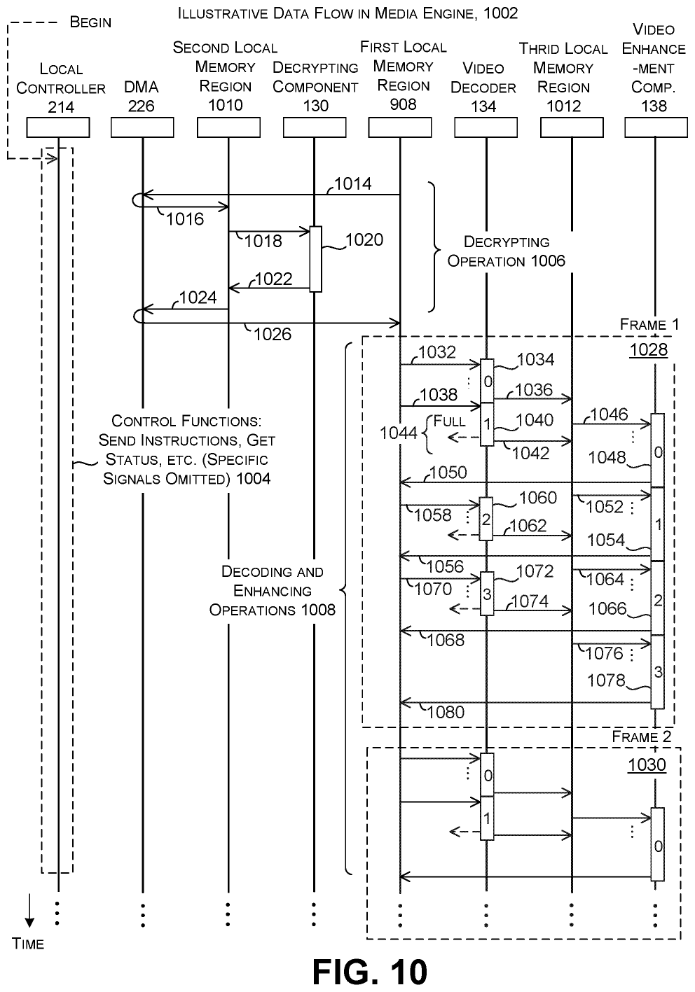

FIG. 9 is a timing diagram that describes a data flow 902 in the client system 106 as a whole according to one implementation, while FIG. 10 is a timing diagram that more specifically describes a data flow 1002 in the media engine 110 in one implementation. In both diagrams, the vertical axis represents time. Arrows represent the transmission of data between components. Vertical bars represents processing performed by particular respective components identified at the tops of the figures. The flow of operations shown in these two figures is an example of one possible implementation; other implementations may vary any aspect of the flow of operations shown in these figures, such as the order of operations and the kinds of operations that are performed.

Beginning with FIG. 9, arrow 904 represents the flow of media data from the communication component 126 to the preprocessing component 128. Arrow 906 represents the flow of media data from the preprocessing component 128 to a first local memory region 908, e.g., corresponding to the system cache 202 and/or any of the local buffers 218 and/or any other form(s) of local memory. Arrow 910 represents the flow of media data from the first local memory region 908 to the media engine 110. Bar 912 represents the processing of the media data by the media engine 110, to produce enhanced media data. Arrow 914 represent the storage of enhanced video data in the first local memory region 908. Arrow 916 represents the retrieval of enhanced video data from the first local memory region 908, and the passage of that data to the video output device 320. Arrow 918 represents the retrieval of enhanced audio data from the first local memory region 908, and the transfer of that data to the audio output device 410.

In FIG. 10, the dashed-line box 1004 indicates that the local controller 214 generally controls the execution of the video-processing operations in the media engine 110. In particular, the local controller 214 sends signals to individual components of the media engine 110, instructing them when to begin processing. In addition, the local controller 214 receives status information from the components regarding their progress in processing the media data. However, so as not to unduly complicate the depicted flow of operations, FIG. 10 omits illustration of the individual control signals. The entire flow commences when the local controller 214 receives a start instruction from the main processing system 208. The main processing system 208 thereafter plays no significant role in the media-processing operations.

By way of overview, the processing shown in FIG. 10 includes a decrypting operation 1006 followed by interleaved decoding and enhancing operations 1008. Assume that the media engine 110 performs the operations shown in FIG. 10 using the local memory 216 of the media engine 110. FIG. 10 shows the local memory 216 as including three regions: the first local memory region 908, a second local memory region 1010, and a third local memory region 1012. Generally, the local memory 216 can include any of the local buffers 218 and/or the system cache 222 shown in FIG. 1 and/or other form(s) of local memory. For example, the three local memory regions (908, 1010, 1012) may correspond to different local buffers. In another example, the first local memory region 908 corresponds to the system cache 222, and the second local memory region 1010 and the third local memory region 1012 correspond to two local buffers. Still other implementations of local memory are possible. Generally, the media engine 110 uses the second local memory region 1010 and the third local memory region 1012 to expedite its operations, but other implementations can omit use of these two local memory regions.

In the decrypting operation 1006, arrows 1014 and 1016 represents the use of the DMA controller 226 to transfer media from the first local memory region 908 to the second local memory region 1010. Arrow 1018 represents the flow of data from the second local memory region 1010 to the decrypting component 130. Bar 1020 represents the decryption of the media data to produce decrypted media data. Arrow 1022 represents the transfer of decrypted media data to the second local memory region 1010. Arrows 1024 and 1026 represent the use of the DMA controller 226 to move the decrypted media data from the second local memory region 1010 to the first local memory region 908. Note that the transfer of data to and from the second local memory region 1010 can occur in multiple steps, although not shown in FIG. 10. Overall, the flow of decryption operations shown FIG. 10 represents a form of inline decryption. “Inline decryption” refers to security processing that is part of the integrated flow media-processing operations performed by the media engine 110, occurring as a part of the pipeline, rather than decryption that relies on an out-of-band general-purpose decryption tool, e.g., which are accessible by interacting with the main processing system 208. Subsequent parts of the processing shown in FIG. 10 are “inline” for the same reason.

In some implementations, the video decoder 134 and the video enhancement component 138 operate on successive frames of video data. FIG. 10 illustrates the processing of a single video frame in stage 1028, and the processing of a next video frame in stage 1030 (only the first part of which is shown in FIG. 10). Further, in some implementations, the video decoder 134 and the video enhancement component 138 perform work on a prescribed amount of video data at any given time. In the illustrative example of FIG. 10, assume that the video decoder 134 processes each frame in a series of four parts, corresponding to block 0, block 1, block 2, and block 3. Each block includes a group of tiles. The video enhancement component 138 correspondingly performs work on the decoded video data produced by the video decoder 134 in a series of four stages. Other implementations process the video frames as respective wholes without the use of tiles, or perform processing in stages in a different manner than shown in FIG. 10.

The operation of the video enhancement component 138 occurs in parallel with the operation of the video decoder 134. But the work of the video enhancement component 138 is delayed with respect to the work of the video decoder 134 (insofar as the video enhancement component 138 can only begin working on the decoded video data once it is produced by the video decoder 134). Finally, assume that, in some implementations, the process of enhancing decoded video data takes more time than the process of decoding decrypted video data. In view of this fact, the local controller 214 schedules the flow of operations such that, when the video enhancement component 138 finishes a current block of decoded video data, it has immediate access to a new block of decoded video data. In other words, the local controller 214 ensures that the video enhancement component 138 is kept busy until the frame of video data has been processed, and is not starved of decoded video data.

Arrow 1032 represents the transfer of the first block of decrypted video data for the first frame from the first local memory region 908 to the video decoder 134. Bar 1034 represents the processing of the first block of decrypted data by the video decoder 134. Arrow 1036 represents the transfer of decoded video data for the first block to the third local memory region 1012. In some implementations, the third local memory region 1012 specifically functions as a ring buffer. A write pointer indicates the location at which new decoded video data can be added by the video decoder 134. A read pointer indicates the location at which previously stored video data can be read by the video enhancement component 138. The local controller 214 updates these pointers as decoded video data in the second buffer 1012 is consumed by the video enhancement component 138.

Arrow 1038 represents the transfer of the second block of decoded video data from the first local memory region 908 to the video decoder 134. Bar 1040 represents the processing of the second block of decrypted data by the video decoder 134. Arrow 1042 represents the transfer of decoded video data for the second block to the third local memory region 1012. Arrow 1044 represents the video decoder's transmission of status information to the local controller 214, which indicates that the third local memory region 1012 is now full (because it stores two blocks of decoded video data). This is an implementation-specific threshold, and can be varied in other implementations. Further note that the video decoder 134 and the video enhancement component 138 send instances of status information to the local controller 214 throughout their operation, but FIG. 10 omits these signals so as not to overcomplicate the drawing. The video decoder 134 enters a low power mode when the third local memory region 1012 is full. In part, the low power mode is achieved by reducing a decoder clock cycle.

Arrow 1046 represents the transfer of the first block of decoded video data from the third local memory region 1012 to the video enhancement component 138. In some implementations, this transfer alternatively occurs in plural stages, each stage transferring one or more tiles of the first block, as represented in FIG. 10 with ellipsis. (The same is true for other memory transfers described herein.) Bar 1048 indicates the processing of the first block of decoded video content by the video enhancement component 138. Arrow 1050 represents the transfer of enhanced video data for the first block from the video enhancement component 138 to the first local memory region 908. Similarly, arrow 1052 represents the transfer of a second block of decoded video data from the third local memory region 1012 to the video enhancement component 138. Bar 1054 represents the processing of the second block of decoded video data. Arrow 1056 represents the transfer of enhanced video data for the second block to the first local memory region 908.

The successful enhancement of the first block of decoded video data frees up the third local memory region 1012 to store a new block of decoded video data. In response, the local controller 214 instructs the video decoder 134 to continue decoding the video frame. Arrow 1058 represents the transfer of the third block of decrypted video data from the first local memory region 908 to the video decoder 134. Bar 1060 represents the processing of the third block of decrypted video data by the video decoder 134. Arrow 1062 represents the transfer of the third block of decoded video data from the video decoder 134 to the third local memory region 1012. Arrow 1064 represents the transfer of the third block of decoded video data from the third local memory region 1012 to the video enhancement component 138. Bar 1066 represents the processing of the third block of video data by the video enhancement component 138. Arrow 1068 represents the transfer of enhanced video data for the third block from the video enhancement component 138 to the first local memory region 908.

Arrow 1070 represents the transfer of the fourth block of decrypted video data from the first local memory region 908 to the video decoder 134. Bar 1072 represents the processing of the fourth block of decrypted video data by the video decoder 134. Arrow 1074 represents the transfer of the fourth block of decoded video data from the video decoder 134 to the third local memory region 1012. Arrow 1076 represents the transfer of the fourth block of decoded video data from the third local memory region 1012 to the video enhancement component 138. Bar 1078 represents the processing of the fourth block of video data by the video enhancement component 138. Arrow 1080 represents the transfer of enhanced video data for the fourth block from the video enhancement component 138 to the first local memory region 908.

The above-described process is repeated for subsequent frames. A component enters a low power mode whenever it is idle. At the ultimate completion of the processing of the received media data, the local controller 214 informs the main processing system 208 that the processing job has been completed.

In summary, FIG. 10 indicates that media engine 110 performs all of the media-processing operations in a local manner, without burdening the main processing system 208. Further, the media engine 110 stores intermediary results in the local memory 216. This eliminates or reduces the need for interaction with off-engine memory resources (which are “remote” with respect to the location at which the media-processing operations are performed), such as the main memory 210.

As a first benefit, the above characteristics improve the latency of the client system 106. For instance, consider an alternative case in which the main processing system 208 coordinates interaction among standalone resources, along with its other control responsibilities. Such standalone resources may include a general-purpose decryption engine, a general-purpose decoding engine, and a general-purpose artificial intelligence engine. Any application may access and interact with these components. In the present case, the media engine 110 uses the dedicated local controller 214 to govern the media-processing operations, which is more efficient than the alternative case. This is because, in the alternative case, the main processing system 208 controls the client system 106 as a whole, and these other control functions can interfere with the efficient management of the media-processing operations. Further, the control functions performed by the main processing system 208 are general-purpose in nature, and are not optimized to coordinate the activity of a consolidated set of local media-processing components. As a further consequence, the use of local controller 214 can increase the efficiency of other tasks performed by the client system 106, as the scheduling and performance of these tasks no longer need to directly compete with the resource-intensive media-processing operations.

Further, it takes less time to interact with local resources (such as local memory 216) compared to remote resources (such as the remote main memory 210). In part, this is because interaction with remote resources generally requires additional processing steps that are not required when interacting with local resources, and involves interaction with a greater number of components compared to interacting with local resources. Further, interaction with remote resources may involves transmitting media data over greater distances (compared to the case of interacting with local resources).

As a second benefit, the above characteristics enable the client system 106 to reduce its consumption of client-system resources, including processing resources, memory resources, communication resources, and power. For instance, the transfer of media data to and from remote components requires more energy than the transfer of media data to and from the local memory 216. Hence, the media engine 110 lowers the consumption of power in the client system 106 relative to alternative solutions. Further, the use of dedicated enhancement components (e.g., the video enhancement component 138 and the audio enhancement component 140) avoids the need for a large and general-purpose artificial intelligence (AI) accelerator. The dedicated enhancement components consume less client-system resources compared to the general-purpose AI accelerator. Reducing the power requirements of the client system 106 has the further effect of reducing the amount of heat it produces while running, and extending its battery life. All types of client systems benefit from the above-described reduction in resources, but the reduction is particularly useful for client devices having resource-constrained platforms and/or client systems that are powered by battery and/or client devices that are subject to any other environment-specific energy-consumption restrictions. That is, for example, the reduction prevents the media-processing operations from overwhelming the resources of a resource-constrained portable computing device and unduly draining its battery.

As a third benefit, the above characteristics allow a developer to reduce the overall size of the client system 106. For example, the consolidation of media-processing components reduces the complexity of the interconnection paths in the client system 106. Further, the simplification of the AI functionality in the client system 106 decreases the footprint of the client system 106.

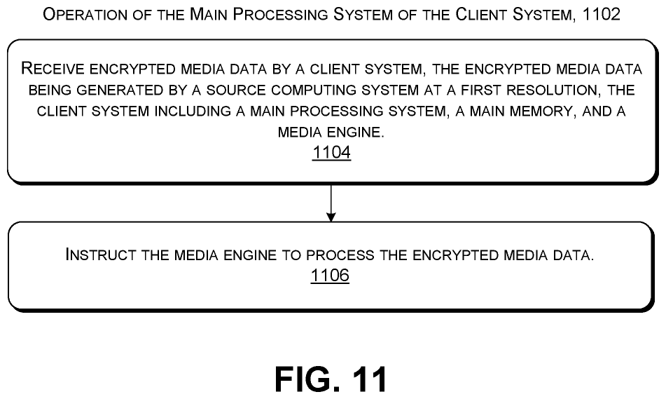

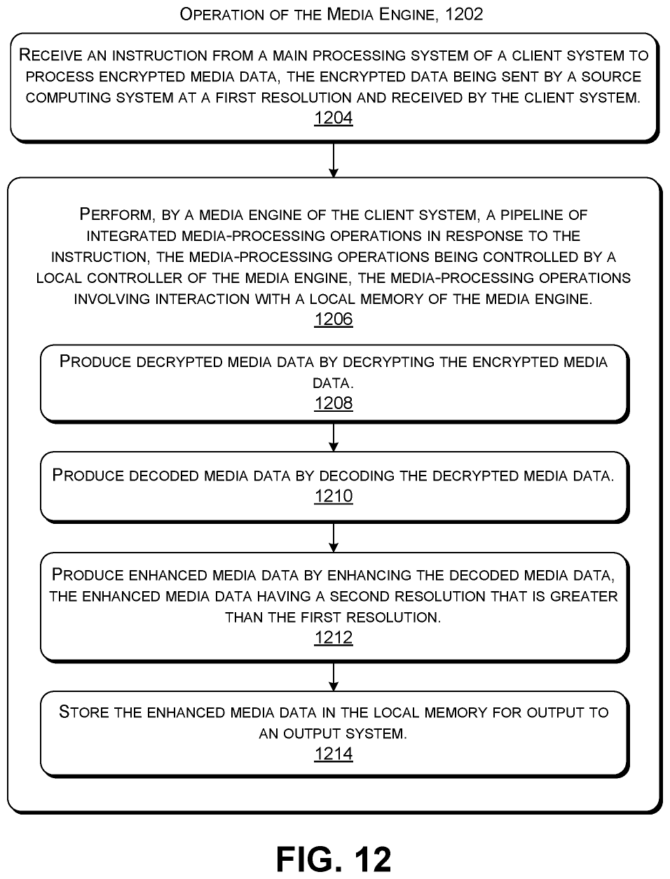

FIGS. 11 and 12 show processes (1102, 1202) that explain the operation of the client system 106. Each process is expressed as a series of operations performed in a particular order. But the order of these operations is merely representative, and the operations are capable of being varied in other implementations. Further, any two or more operations described below can be performed in a parallel manner.

More specifically, FIG. 11 shows a process 1102 for initiating the processing of media data. In block 1104, the client system 106 receives encrypted media data. The encrypted media data is generated by a source computing system (such as the server system 104) at a first (reduced) resolution R1. The client system 106 includes the main processing system 208, the main memory 210, and the media engine 110. In block 1106, the main processing system 208 instructs the media engine 110 to process the encrypted media data.

FIG. 12 shows a process 1202 that describes one manner of operation of the media engine 110. In block 1204, the media engine 110 receives an instruction from the main processing system 208 of the client system 106 to process encrypted media data. As noted above, the encrypted data is received by the client system 106 from a source computing system (such as the server system 104) at the first resolution R1. In block 1206, the media engine 110 performs a pipeline of integrated media-processing operations in response to the instruction. The media-processing operations are controlled by the local controller 214 of the media engine 110. Further, the media-processing operations involve interaction with the local memory 216 of the media engine 110.

Upon commencement of the media-processing operations, in block 1208 (corresponding to a decrypting operation), the media engine 110 produces decrypted media data by decrypting the encrypted media data. In block 1210 (corresponding to a decoding operation), the media engine 110 produces decoded media data by decoding the decrypted media data. In block 1212 (corresponding to an enhancing operation), the media engine 110 produces enhanced media data by enhancing the decoded media data. The enhanced media data has a second resolution R2 that is greater than the first resolution R1 (that is, R2>R1). In block 1214, the media engine 110 stores the enhanced media data in the local memory 216 for output to an output system.

The following summary provides a set of illustrative examples of the technology set forth herein.
(A1) According to a first aspect, a method (e.g., the process 1202) is described for processing streamed media data. The method includes receiving (e.g., in block 1204) an instruction from a main processing system (e.g., the main processing system 208) of a client system (e.g., the client system 106) to process encrypted media data. The encrypted media data is sent by a source computing system (e.g., the server system 104) at a first resolution and received by the client system. The method further includes performing (e.g., in block 1206), by a media engine (e.g., the media engine 110) of the client system, a pipeline of integrated media-processing operations in response to the instruction. The media-processing operations are controlled by a local controller (e.g., the local controller 214) of the media engine. The media-processing operations involve interaction with a local memory (e.g., the local memory 216) of the media engine. The media-processing operations include: in a decrypting operation, producing (e.g., in block 1208) decrypted media data by decrypting the encrypted media data; in a decoding operation, producing (e.g., in block 1210) decoded media data by decoding the decrypted media data; in an enhancing operation, producing (e.g., in block 1212) enhanced media data by enhancing the decoded media data, the enhanced media data having a second resolution that is greater than the first resolution; and storing (e.g., in block 1214) the enhanced media data in the local memory for output to an output system (e.g., the output devices 146).
(A2) According to some implementations of the method of A1, the method further includes verifying that a target entity (e.g., the client system and/or the user who interacts with the client system) has rights to consume the decrypted media data.
(A3) According to some implementations of any of the methods of A1 or A2, the enhancing operation data uses a machine-trained model to map the decoded media data at the first resolution to the enhanced media data at the second resolution.
(A4) According to some implementations of any of the methods of A1-A3, the decoding operation includes storing the decoded media data in the local memory, and the enhancing operation data includes retrieving the decoded media data from the local memory.
(A5) According to some implementations of the method of A4, the method further includes controlling a portion of the local memory which stores the decoded media data as a ring buffer.
(A6) According to some implementations of any of the methods of A1-A5, the enhancing operation operates, at least in part, in parallel with the decoding operation.
(A7) According to some implementations of any of the methods of A1-A6, the enhancing operation takes more time to generate output results compared to the decoding operation, and the local controller governs the decoding operation based, in part, on status information that indicates a status of the enhancing operation.
(A8) According to some implementations of any of the methods of A1-A7,the media-processing operations further include separating the decrypted media data into decrypted video data and decrypted audio data.
(A9) According to some implementations of the method of A8, the decoding operation includes, in a video decoding operation, producing decoded video data by decoding the decrypted video data, and the enhancing operation includes, in a video enhancing operation, producing enhanced video data by enhancing the decoded video data.
(A10) According to some implementations of the method of A9, the video decoding operation includes storing plural tiles of decoded video data in the local memory, and the video enhancing operation includes retrieving the plural tiles of decoded video data from the local memory.
(A11) According to some implementations of any of the methods of A9 or A10, the method further includes modifying the decoded video data from a first format to a second format, the second format being different than the first format.
(A12) According to some implementations of any of the methods of A9-A11, the method further includes modifying the enhanced video data from a third format to a fourth format, the fourth format being different than the third format.
(A13) According to some implementations of any of the methods claims A9-A12, the decoding operation includes producing decoded audio data by decoding the decrypted audio data, and the enhancing operation includes producing enhanced audio data by enhancing the decoded audio data.
(A14) According to some implementations of any of the methods of A1-A13, the client system is implemented, at least in part, as a system-on-chip, and wherein the media engine is a component of the system-on-chip.
(A15) According to some implementations of any of the methods of A1-A14, the source computing system is a server system.
(B1) According to a second aspect, a computing system (e.g., the client system 106) for streaming media data is described. The computing system includes a main processing system (e.g., the main processing system 208) and a main memory (e.g., the main memory 210), and a media engine (e.g., the media engine 110) having a local controller (e.g., the local controller 214) and a local memory (e.g., the local memory 216). The main processing system executes machine-readable instructions to perform operations including: receiving (e.g., in block 1104) encrypted media data, the encrypted media data being generated by a source computing system (e.g., the server system 104) at a first resolution; and instructing (e.g., in block 1106) the media engine to process the encrypted media data. The media engine executes machine-readable instructions to perform a pipeline of integrated media-processing operations in response to the instructing. The media-processing operations are controlled by the local controller and utilize the local memory. The media-processing operations include: in a decrypting operation, producing (e.g., in block 1208) decrypted media data by decrypting the encrypted media data; in a decoding operation, producing (e.g., in block 1210) decoded media data by decoding the decrypted media data; in an enhancing operation, producing (e.g., in block 1212) enhanced media data by enhancing the decoded media data, the enhanced media data having a second resolution that is greater than the first resolution; and storing (e.g., in block 1214) the enhanced media data in the local memory for output to an output system (e.g., the output devices 146).

In yet another aspect, some implementations of the technology described herein include a computing system (e.g., the client system 106) that includes a processing system (e.g., the main processing system 208 and/or the local controller 214). The computing system also includes a storage device (e.g., the main memory 210 and/or the instruction storage embodied in the local controller 214) for storing computer-readable instructions. The processing system executes the computer-readable instructions to perform any of the methods described herein (e.g., any individual method of the methods of A1-A15 or B1).

In yet another aspect, some implementations of the technology described herein include a computer-readable storage medium (e.g., the main memory 210 and/or the storage embodied in the local controller 214) for storing computer-readable instructions. A processing system (e.g., the main processing system 208 and/or the local controller 214) executes the computer-readable instructions to perform any of the operations described herein (e.g., the operation in any individual method of the methods of A1-A15 or B1).

More generally stated, any of the individual elements and steps described herein are combinable into any logically consistent permutation or subset. Further, any such combination is capable of being be manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example. Further, any mention of a single entity is not intended to preclude the use of plural such entities; similarly, a description of plural entities in the specification is not intended to preclude the use of a single entity. As such, a statement that an apparatus or method has a feature X does not preclude the possibility that it has additional features. Further, any features described as alternative ways of carrying out identified functions or implementing identified mechanisms are also combinable together in any combination, unless otherwise noted.

As to specific terminology used in this description, the phrase “configured to” encompasses various physical and tangible mechanisms for performing an identified operation. The mechanisms are configurable to perform an operation using the processing systems of FIG. 2. The term “logic” likewise encompasses various physical and tangible mechanisms for performing a task. For instance, each processing-related operation illustrated in the flowcharts of FIGS. 11 and 12 corresponds to a logic component for performing that operation.

Any of the storage resources described herein, or any combination of the storage resources, is to be regarded as a computer-readable medium. In many cases, a computer-readable medium represents some form of physical and tangible entity. The term computer-readable medium also encompasses propagated signals, e.g., transmitted or received via a physical conduit and/or air or other wireless medium. However, the specific term “computer-readable storage medium” or “storage device” expressly excludes propagated signals per se in transit, while including all other forms of physical computer-readable media; a computer-readable storage medium or storage device is itself “non-transitory” in this regard.

The term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are nonce terms used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for processing streamed media data, comprising:
receiving an instruction from a main processing system of a client system to process encrypted media data, the encrypted media data being sent by a source computing system at a first resolution and received by the client system;
performing, by a media engine of the client system, a pipeline of integrated media-processing operations in response to the instruction,
the media-processing operations being controlled by a local controller of the media engine,
the media-processing operations involving interaction with a local memory of the media engine,
the media-processing operations including:
in a decrypting operation, producing decrypted media data by decrypting the encrypted media data;
in a decoding operation, producing decoded media data by decoding the decrypted media data;
in an enhancing operation, producing enhanced media data by enhancing the decoded media data, the enhanced media data having a second resolution that is greater than the first resolution; and
storing the enhanced media data in the local memory for output to an output system.

2. The method of claim 1, further including verifying that a target entity has rights to consume the decrypted media data.

3. The method of claim 1, wherein the enhancing operation data uses a machine-trained model to map the decoded media data at the first resolution to the enhanced media data at the second resolution.

4. The method of claim 1,
wherein the decoding operation includes storing the decoded media data in the local memory, and
wherein the enhancing operation data includes retrieving the decoded media data from the local memory.

5. The method of claim 4, wherein the method further comprises controlling a portion of the local memory which stores the decoded media data as a ring buffer.

6. The method of claim 1, wherein the enhancing operation operates, at least in part, in parallel with the decoding operation.

7. The method of claim 1,
wherein the enhancing operation takes more time to generate output results compared to the decoding operation, and
wherein the local controller governs the decoding operation based, in part, on status information that indicates a status of the enhancing operation.

8. The method of claim 1, wherein the media-processing operations further include separating the decrypted media data into decrypted video data and decrypted audio data.

9. The method of claim 8,
wherein the decoding operation includes, in a video decoding operation, producing decoded video data by decoding the decrypted video data, and
wherein the enhancing operation includes, in a video enhancing operation, producing enhanced video data by enhancing the decoded video data.

10. The method of claim 9,
wherein the video decoding operation includes storing plural tiles of decoded video data in the local memory, and
wherein the video enhancing operation includes retrieving the plural tiles of decoded video data from the local memory.

11. The method of claim 9, further comprising modifying the decoded video data from a first format to a second format, the second format being different than the first format.

12. The method of claim 9, further comprising modifying the enhanced video data from a first format to a second format, the second format being different than the first format.

13. The method of claim 8,
wherein the decoding operation includes producing decoded audio data by decoding the decrypted audio data, and
wherein the enhancing operation includes producing enhanced audio data by enhancing the decoded audio data.

14. The method of claim 1, wherein the client system is implemented, at least in part, as a system-on-chip, and wherein the media engine is a component of the system-on-chip.

15. The method of claim 1, wherein the source computing system is a server system.

16. A computing system for streaming media data, comprising:
a main processing system and a main memory;
a media engine having a local controller and a local memory;
the main processing system executing machine-readable instructions to perform operations including:
receiving encrypted media data, the encrypted media data being generated by a source computing system at a first resolution; and
instructing the media engine to process the encrypted media data,
the media engine executing machine-readable instructions to perform a pipeline of integrated media-processing operations in response to the instructing,
the media-processing operations being controlled by the local controller and utilizing the local memory, the media-processing operations including:
in a decrypting operation, producing decrypted media data by decrypting the encrypted media data;
in a decoding operation, producing decoded media data by decoding the decrypted media data;
in an enhancing operation, producing enhanced media data by enhancing the decoded media data, the enhanced media data having a second resolution that is greater than the first resolution; and
storing the enhanced media data in the local memory for output to an output system.

17. The computing system of claim 16,
wherein the media-processing operations further include separating the decrypted media data into decrypted video data and decrypted audio data,
wherein the decoding operation includes producing decoded video data by decoding the decrypted video data, and producing decoded audio data by decoding the decrypted audio data, and
wherein the enhancing operation includes producing enhanced video data by enhancing the decoded video data, and producing enhanced audio data by enhancing the decoded audio data.

18. The computing system of claim 16, wherein the computing system is implemented, at least in part, as a system-on-chip, and wherein the media engine is a component of the system-on-chip.

19. A computer-readable storage medium for storing computer-readable instructions, a client system executing the computer-readable instructions to perform operations, the operations comprising:
receiving an instruction from a main processing system of the client system to process encrypted media data, the encrypted media data being sent by a source computing system at a first resolution and received by the client system;
performing, by a media engine of the client system, a pipeline of integrated media-processing operations in response to the instruction,
the media-processing operations being controlled by a local controller of the media engine,
the media-processing operations involving interaction with a local memory of the media engine,
the media-processing operations including:
in a decrypting operation, producing decrypted media data by decrypting the decrypted media data, and storing the decrypted media data in the local memory;
in a decoding operation, producing decoded media data by decoding the decrypted media data, and storing the decoded media data in the local memory; and
in an enhancing operation, producing enhanced media data by enhancing the decoded media data, and storing the enhanced media data in the local memory, the enhanced media data having a second resolution that is greater than the first resolution.

20. The computer-readable storage medium of claim 19,
wherein the media-processing operations further include separating the decrypted media data into decrypted video data and decrypted audio data,
wherein the decoding operation includes producing decoded video data by decoding the decrypted video data, and producing decoded audio data by decoding the decrypted audio data, and
wherein the enhancing operation includes producing enhanced video data by enhancing the decoded video data, and producing enhanced audio data by enhancing the decoded audio data.
